(19) United States
(12) Patent Application Publication
(10) Pub. No.: US 2012/0206748 A1
(43) Pub. Date: Aug. 16, 2012

(54) LANGUAGE MONITOR APPLICATION LAUNCH

(75) Inventors: Steven K. Hines, San Francisco, CA (US); Sharmila Padmanabhan, San Diego, CA (US)

(73) Assignee: Hewlett-Packard Development Company LP

(21) Appl. No.: 13/024,744

(22) Filed: Feb. 10, 2011

(51) Int. Cl. G06F 3/12

(52) U.S. Cl. 358/1.13

(57) ABSTRACT

An apparatus and method use a language monitor of a print driver to identify a print job related application external to the print driver and to direct one or more processors to launch the print job related application.

### BACKGROUND

Print drivers interface between an operating system of a computing device and a printer to control print path related processes. Deploying new print path related processes may require cumbersome print driver updates or a reinstallation of a new print driver.

### BRIEF DESCRIPTION OF THE DRAWINGS

FIG. 1 is a schematic illustration of a printing system according to an example embodiment.

FIG. 2 is a flow diagram of a process performed by the printing system of FIG. 1 according to an example embodiment.

FIG. 3 is a flow diagram of another embodiment of the example process of FIG. 2.

FIG. 4 is a flow diagram of another embodiment of the example process of FIG. 2.

FIG. 5 is a flow diagram of an example sub process of the process of FIG. 2.

### DETAILED DESCRIPTION OF THE EXAMPLE EMBODIMENTS

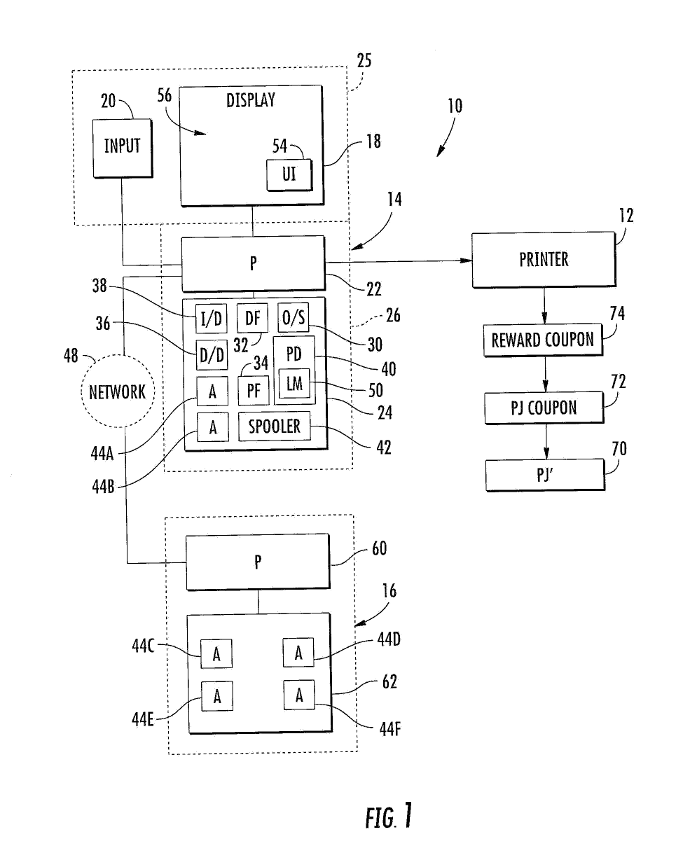

FIG. 1 is a schematic illustration of a printing system 10 according to an example embodiment. As will be described hereafter, printing system 10 enables print path related processes to be modified without requiring print driver updates or reinstallation of a new print driver. Printing system 10 utilizes a language monitor of a print driver to identify and launch external print job or print path related applications. In some embodiments, the external print job related applications may add supplemental print jobs to a print stream.

As shown by FIG. 1, printing system 10 comprises printer 12, printer host 14 and server 16. Printer 12 comprises a device configured to print or deposit printing material, such as ink or toner, upon a print medium to form textual or graphic images upon the print medium. Examples of printer 12 include, but are not limited to, inkjet printers, liquid electrophotography (LEP) printers, and laser printers. In the example illustrated, printer 12 comprises a bidirectional printer. The print medium upon which the images are formed may comprise individual sheets or a web.

Printer host 14 supplies print jobs to printer 12. Printer host 14 comprises display 18, input 20, processor 22 and memory 24. In one embodiment, display 18 and input 28 may be provided as part of a single component 25 (an example of which is a touch screen monitor) distinct from processor 22 and memory 24 which are also provided as part of a separate component 26 (an example of which is a desktop). In another embodiment, printer host 14 may comprise a single unitary electronic component such as a net book, laptop, personal data assistant, cell phone, or other electronic device that communicates with printer 12 for printing. Such print jobs provided by printer host 14 may originate with printer host 14 or may originate from other sources, such as other electronic devices on a network. For purposes of this disclosure, the term “network” comprises both local area networks (LANs) and the internet or World Wide Web.

Display 18 comprises one or more device configured to provide visual information or data to a person. Display 18 operates under the control of processor 22. In one embodiment, display 18 may comprise a screen or monitor.

Input 20 comprises one or more devices configured to facilitate the input of commands or selections to processor 22. Examples of input 20 include, but are not limited to, one or more of the following: a mouse, a keyboard, a keypad, a touchpad, a stylus, a microphone with speech recognition technology, or a touch screen. In one embodiment, the touch screen serving as input 20 may be formed as part of display 18.

Processor 22 comprises one or more processing units, at one location or at multiple separate locations, configured to carry out processes or operations and generate control signals based upon commands received through input 20 and according to instructions or routines stored as software, code or data in memory 24. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, processor 22 may be embodied as part of one or more application-specific integrated circuits (ASICs). Unless otherwise specifically noted, processor 22 is not limited to any specific combination of hardware circuitry and software, nor to any particular source for the instructions executed by the processing unit. For purposes of this disclosure, it should be understood that functions, programs, routines or steps described as being performed or carried out by stored software, code and data in memory 24 is performed by the one of more processors 22 following the instructions contained in the particular stored software, code and data in memory 24.

Memory 24 comprises one or more persistent storage structures configured to store data, software or code, programs and the like. Examples of memory 24 include, but are not limited to, random access memory (RAM), read only memory (ROM), a mass storage device (tape, disk, flash), or some other persistent storage. Memory 24 comprises and stores operating system 30, data files 32, program files 34, display driver 36, input driver 38, print driver 40, spooler 42 and print job related applications 44A, 44B (collectively referred to as print job related applications 44).

Operating system 30 comprises software or programming stored in memory 24. Operating system 30 facilitates interface between a person and printing system 10. In one embodiment, operating system 32 is installed onto a main memory comprising a hard disk drive. In one embodiment, operating system 30 may comprise a disk operating system (DOS). One example of a DOS operating system is an operating system that runs on machines with INTEL X86 or compatible central processing units. One example of such an operating system is a WINDOWS based operating system such as WINDOWS XP, WINDOWS VISTA or WINDOWS 7 operating systems. Other examples of operating systems include, but are not limited to, LINUX, Mac OS X, Solaris, BSD and Amiga OS.

Data files 32 comprise file of data such as photos, music, text, graphics and combinations thereof. Program files 34 comprise executable files which carry out programs. Such programs may generate additional data files 32 or may interact with data files 32 to modify existing data files 32. In some embodiments, program files 34 may create or modify data files 32 to be printed on printer 12. Program files 34 may additionally include files (such as a browser) for interfacing with other sources of data, such as sources located across a network 48.

Display driver 36 comprises a device driver configured to facilitate communication between operating system 30 and display 18. Display driver 36 is dependent upon the particular type of operating system 30 and the particular type of display 18. Similar to display driver 36, input driver 38 comprises a device driver configured to facilitate communication between operating system 30 and input 20. Display driver 36 is dependent upon the particular type of operating system 30 and the particular type of input 20. Both display driver 36 and input driver 38 act as translators by accepting generic high-level commands from operating system 30 and breaking the commands into a series of low-level device-specific commands as required by display 18 and input 20, respectively.

Print driver 40 comprises a device driver configured to facilitate communication between operating system 30 and printer 12. As with display driver 36 and input driver 38, print driver 40 is dependent upon the particular type of operating system 30 and the particular type of printer 12. As with display driver 36 and input driver 38, print driver 40 acts as translator by accepting generic high-level commands from operating system 30 and breaking the commands into a series of low-level device-specific commands as required by printer 12. In particular, print driver 40 converts application data to a print job that may be read or understood by the hardware of printer 12. One example of a print job is application data converted to print job language. Once a print job is created, print driver 40 transmits the print job to spooler 42. Spooler 42 stores such print jobs in a spool or queue while the print jobs await printing by printer 12.

Print driver 40 includes language monitor 50. Language Monitor 50 provides full-duplex communication between the print spooler 42 and printer 12 to provide software-accessible status information. For purposes of this disclosure, the term “language Monitor” shall mean any device that provides, amongst other possible functions, duplex communication between a print spool or and a printer to provide software-accessible status information. The language monitor 50 adds printer control information, such as commands defined by a printer job language, to the data stream. In the embodiment illustrated, language monitor 50 and an AsyncUl communication mechanism are implemented by operating system 30) for job control and messaging, for example, notifying a person that the printer 12 is out of paper.

In addition to facilitating print-job control and messaging, language monitor 50 is additionally configured to launch print job or print path related applications external to language monitor 50 and print driver 40. In one embodiment, language monitor 50 is configured to check or search for the existence of external print job or print path related applications and, if they exist, launch them. As a result, new or updated print job or print path related applications may be executed during printing operations despite the fact that such new or updated print job or print path related applications may not have been accessible or may not have been installed when the original print driver 40 was installed.

In one embodiment, language monitor 50 is further configured to display a user interface 54 on display 18, providing a person with the option of selecting whether or not to execute one or more of any external print job or print path related applications found by language monitor 50.

In other embodiments, language monitor 50 may automatically launch a search application external to print driver 40, wherein the external search application itself searches and identifies additional print job or print path related applications which are launched or which are made available for selection by a person selecting one or more user interfaces 54. In the example illustrated, user interface 54 comprises a graphical user interface presented on display 18 and selectable by a person manipulating a pointer or cursor 56 using input 20. In other embodiments, user interface 54 may have other configurations and its selection may be made in other manners. In one embodiment, language monitor 50 may launch the applications found by the search application. In another embodiment, the search application may, itself, launch the found applications. For purposes of this disclosure, the phrases “found by language monitor 50” or “launched by language monitor 50” or similar phrases encompass both instances where language monitor 50 directly finds or launches an application or indirectly finds or launches an application through one or more intermediate searching or launching applications launched by language monitor 50, respectively.

Applications 44 comprise print job or print path related applications (software, code or programs) stored in the one or more memories 24 external to print driver 40. Applications 44 are generally configured to carry out print path or print job related modifications or functions which are not part of the existing routine or selectable routine of print driver 40. In one embodiment, application 44A comprise an application to adjust or modify the print job prior to the print job being spooled at spooler 42. In one embodiment, application 44B comprises an application configured to add one or more supplemental print jobs to the printer stream in response to the first print job being spooled. Examples of supplemental print jobs include, or not limited to, notifications, promotions, discounts, offers, adds, certificates or coupons.

Server 16 comprises a source of additional print jobs or print path related applications which may be found by language monitor 50 or launched by language monitor 50. Server 16 is communicatively coupled or connected to printer host 14 via network 48. Server 16 comprises processor 60 and memory 62. Processor 60 comprises one or more processing units configured to carry out instructions contained in memory 62.

Memory 62 comprises one or more persistent storage devices including instructions for the one more processor 60. In addition, memory 62 stores print job or print path related applications 44C, 44D, 44E and 44F (collectively referred to as applications 44). Like applications 44A and 44B, applications 44C, 44D, 44E and 44F comprise executable programs which may be found by language monitor 50 and which may be launched by language monitor 50. As noted above, in one embodiment, the launching of one or more of applications 44 may be automatic or may be in response to a person selecting or providing input to one or more user interfaces 54. In some embodiments, some of applications 44 may be automatically launched, whereas other applications 44 are chosen before being launched by language monitor 50. In some embodiments, printing system 10 may include additional servers 16 containing additional print jobs or print path related applications 44. In other embodiments, printing system 10 may omit server 16.

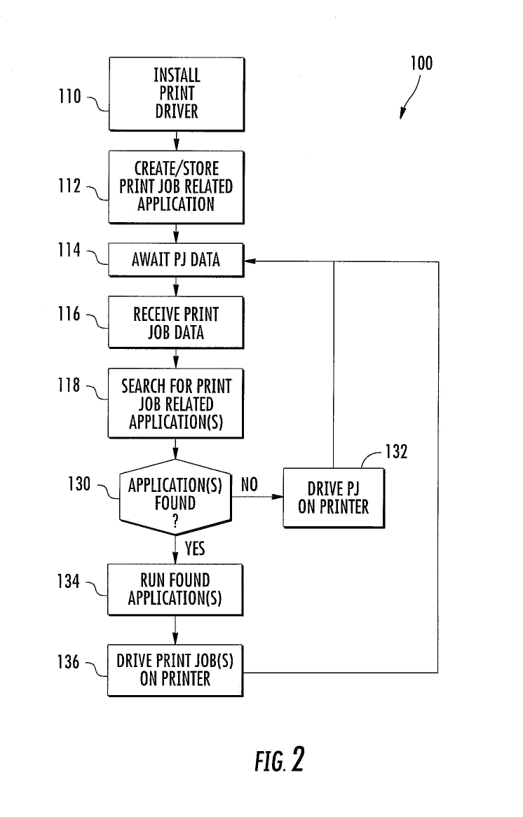

FIG. 2 is a flow diagram of one example method or process 100 that may be carried out by printing system 10. As indicated by block 110, print driver 40 is initially installed in memory 24 and associated with operating system 30. At the time that print driver 40 is installed in memory 24, one or more of print jobs or print path related applications 44 may not be in existence, may not be accessible by printer host 14 or may not be installed in a memory accessible white printer host 14.

As indicated by block 112, one or more of applications 44 are created, stored and/or made accessible to printer host 14. In one embodiment, the one more applications 44 are created, stored and/or made accessible to printer host 14 after print driver 40 is been installed. In another embodiment, the one more applications 44 are created, stored and/or made accessible to printer host 14 before or separate from the installation of print driver 40, providing the later install print driver 40 with additional print job or print path options that might not otherwise be available.

As indicated by block 114, print driver 40 and its language monitor 50 await receipt of print job data (data that has not yet been converted by print driver 40) from operating system 30 (or applications being executed the operating system 30). As indicated by step or block 116, print driver 40 and its language monitor 50 receive print job data. Upon receipt, print driver 40 begins to convert print job data into print job language or commands for printer 12.

As indicated by block 118, language monitor 50 searches for print job or print path related applications 44. In one embodiment, the search may include all memory sources accessible by printer host 14. In another embodiment, the search may include selected memory locations. For example, in one embodiment, language monitor 50 (or an automatically launched search application) may cause display 18 present a user interface allowing a person to identify memories or locations to be searched for the existence of print job or print path related applications.

As indicated by block 130, if an external print job or print path related application is not found by language monitor 50, print driver 40 proceeds to drive the primary print job, the converted print job data, to printer 12 as indicated by block 132. In particular instances, the primary print job may be spooled by spooler 42 for awaiting printing by printer 12.

Alternatively, if print job or print path related applications are found, the found applications are executed as indicated by block 134. As indicated by block 136, print driver 40 drives the print job (based on the original print job data received in step 116 as well as any supplemental print jobs resulting from the execution of the found print job or print path related applications in step 134. As noted above with respect to step 132, the original print job resulting from print job data as well as any supplemental print jobs resulting from the execution of the applications 44 may be spooled by spooler 42 prior to being executed by printer 12 to print upon a print medium.

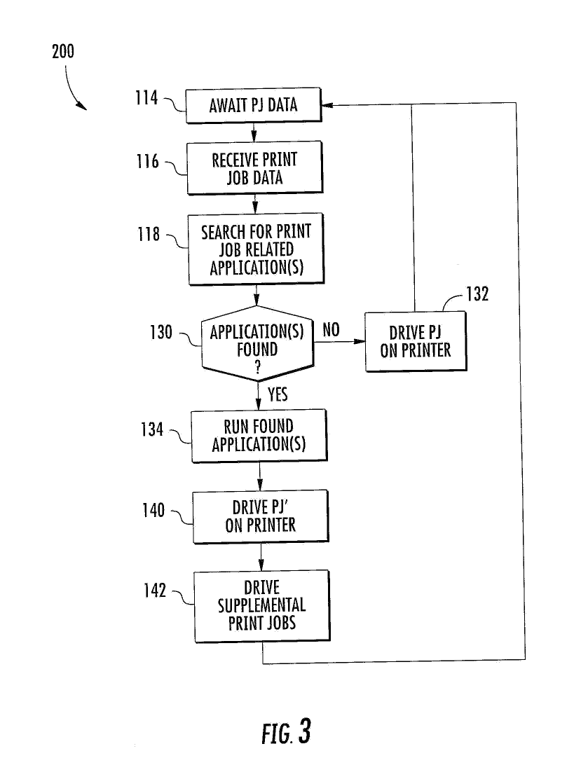

FIG. 3 is a flow diagram illustrating a method or process 200 which may be carried out by printing system 10. Printing system 200 is similar to printing system 100 except that the found applications result in both a modified print job and supplemental print jobs being sent to printer 12. For ease of discussion, those blocks or steps in process 200 which correspond to the same blocks or steps of the process 100 are numbered similarly. Although not shown, process 200 may additionally include blocks or steps 110 and 112 shown in FIG. 2.

As shown by FIG. 3, language monitor 50 (shown in FIG. 1) finds, identifies or locates application 44A, which upon being launched or executed by language monitor 50 (using processor 22) modifies the primary print job PJ that was based upon the originally received print job data in step 116. As indicated by block 140 and shown in FIG. 1, the modified primary print job (PJ′) 70 is transmitted to printer 12 or is spooled by spooler 42 (shown in FIG. 1) until printed by printer 12.

In the example process 200 shown in FIG. 3, language monitor 50 further identifies or finds application 44C on a pre-designated or associated website server 16 (shown in FIG. 1). As indicated by block 142, language monitor 50 launches application 44C which results in a supplemental print job being added to the print stream of printer 12. In the example illustrated and as shown in FIG. 1, the supplemental print job comprises a certificate or coupon 72. The supplemental coupon print job is spooled by spooler 42 until printed by printer 12. In one embodiment, application 44C is executed in response to the primary print job PJ or the modified primary print job PJ′ being spooled. In one embodiment, the supplemental coupon print job is appended to the primary print job PJ or modified primary print job PJ′ in the print stream such that coupon 72 is printed immediately following the printing of the original print job.

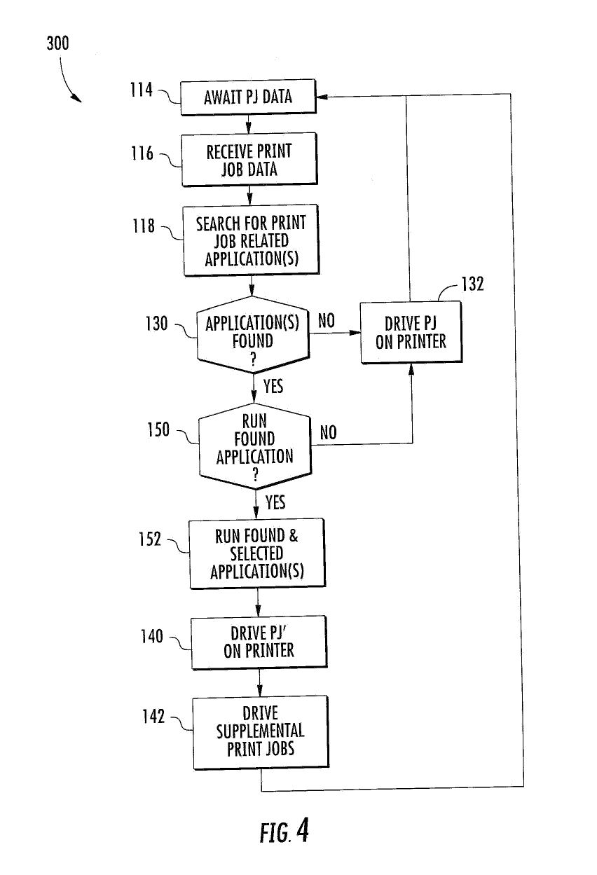

FIG. 4 is a flow diagram of a method or process 300, another embodiment of the method or process 100 shown in FIG. 2. Process 300 is similar to process 200 except that process 300 additionally includes block or step 150 and includes block 152 in place of block 134. The remaining blocks or steps of process 300 which correspond to similar steps in process 200 are numbered similarly.

As indicated by block 150, upon finding one or more print job or print path (print flow) related applications 44, language monitor 50 (shown in FIG. 1) causes (directly or indirectly through an intermediate application) the found applications 44 to be displayed for viewing and selection on display 18. In particular, user interface 54 (shown in FIG. 1) may list or identify each of the found applications, wherein the user may move or position cursor pointer 56 using input 20 to select one or more of the applications 44 for execution. As indicated by step or block 152, language monitor 50 launches and runs the found and selected applications 44.

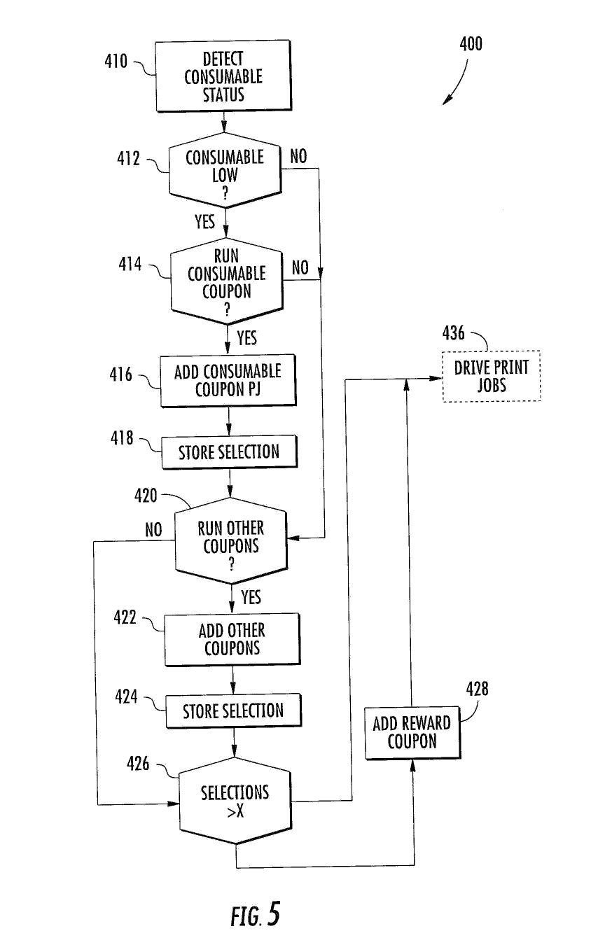

FIG. 5 is a flow diagram illustrating one example method or process 400 resulting from the execution or running of print job or print path related application 44B. As shown by FIG. 5, upon being launched by language monitor 50, application 44B causes the status of a consumable in printer 12 to be detected per block 410. In one embodiment, the particular consumable status being detected is the level of printing material, such as ink or toner, remaining in the printer 12. In another embodiment, the particular consumable status being detected may comprise the level of printing medium, such as sheets of paper, remaining in printer 12.

As indicated by step 412, application 44B compares the detected level or amount of consumable remaining in printer 12 to a threshold. For example, in embodiments where the consumable is the level of ink or toner remaining in printer 12, the threshold may comprise a predefined level of ink or toner at or below which the ink or toner will run out shortly and should be ordered. In one embodiment, the threshold may be fixed. In another embodiment, the threshold may vary according to a formula based upon factors such as a detected rate at which the consumable is being consumed and the time for replenishing the consumable.

As indicated by step 414, if it is determined that the level of consumable in printer 12 is sufficiently low with respect to the threshold, application 44B causes display 18 to present a user interface 54 inquiring as to whether the person wishes to print a coupon for the consumable. The coupon may offer a discount, wherein the coupon is submitted during ordering of the consumable or wherein a code on the coupon is entered during electronic ordering of the consumable. In other embodiments, the coupon may comprise an advertisement or promotional information relating to the consumable.

As indicated in step 416, if the person inputs an affirmation that the consumable coupon should be printed, the coupon print job is appended or added to the primary print job (the print up based upon the receipt print job data) such that the consumable coupon will be printed on a new sheet or successive portion of a web after the primary print job has been printed. As indicated by step 418, application 44B stores and counts or keeps track of the number of times that a person has printed or selected a consumable coupon for printing.

As indicated by step 420, application 44B further causes display 18 to provide a prompt or other user interface asking the person whether he or she wishes to print other coupons, coupon that are not related to consumables of printer 12. Such “other” coupons may comprise coupons, promotions or advertising material for other products or services. In one embodiment, application 44B may cause display 18 to present a list of selectable products or services for which coupons may be printed. As indicated by block or step 422, should a person choose one or more other coupons for printing, the other coupons are slated for printing. As indicated by step 424, application 44B stores and counts or keeps track of the number of times that a person has printed or selected the “other” coupons for printing.

As indicated by step 426, application 44B compares the number of times that a person has selected any coupon for printing to a predetermined reward threshold. As indicated by block 428, if the number of selections or the number of times that a person has requested printing of the coupon exceeds the predetermined reward threshold X, application 44B additionally adds or slates the printing of a reward certificate or reward coupon 74 (shown in FIG. 1). In some embodiments, application 44B may impose additional criteria before the printing of a coupon counts towards a reward. For example, in some embodiments, application 44B may additionally count the print job pages or the ink used in the print job pages, wherein if the print job for the coupon does not meet a minimum threshold for pages or consumed ink, the print job does not count towards the reward threshold. For example, if the user sends a print job of only 1 line it may not qualify for additional ink points or count towards the reward. The reward certificate or reward coupon may be a discount or may be redeemable for one or more products or services.

In one embodiment, the addition of reward certificate or coupon resets or restarts the coupon selection count at zero. In another embodiment, the coupon selection count is not reset, wherein the current running total of coupon prints or selections is compared against a series of multiple increasingly larger thresholds and wherein larger rewards are offered when larger thresholds are met. Although step 426 compares the number of times that any coupon has been printed against the reward threshold X, in other embodiments, application 44B may alternatively (1) just compare the number of printed consumable coupons against the threshold or (2) just compare the number of “other” coupons printed against the predetermined threshold X. In still another embodiment, different thresholds may be provided for different categories of coupons (consumable coupons versus “other” coupons), wherein different rewards are offered when threshold are met for the printing of the different coupon types.

As indicated by step 436, print driver 40 (shown in FIG. 1) drives each of the print jobs to printer 12. In particular, print driver 40 converts the primary print job data, any consumable coupon data, any “other” coupon data as well as any reward coupon data into the appropriate control language for printer 12. The resulting print jobs are spooled by spooler 42 until printed by printer 12. In one embodiment, any consumable coupon print jobs, “other” coupon print jobs and reward coupons are successively printed immediately following the printing of the primary print job. Although the flow diagram in FIG. 5 depicts the print jobs being driven after steps 414, 420 and 426, in other embodiments, primary print job may be printed or spooled prior to step 414. The consumable coupon may be spooled or printed prior to step 420.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
one or more processors configured to add print jobs to a printer print stream; and
a language monitor of a print driver configured to:
receive print jobs from the one or more processors;
identify a print job related application external to the print driver; and
cause the print job related application to be launched.

2. The apparatus of claim 1, wherein the language monitor is configured to trigger the one or more processors to present a selectable user interface and wherein the one or more processors is configured to launch the print job related application in response to the user interface being selected by a person.

3. The apparatus of claim 2, wherein the language monitor is configured to trigger the processor to acquire the print job related application from a source across a communication network.

4. The apparatus of claim 1, wherein the language monitor is configured to trigger the one or more processors to acquire the print job related application from a source across a communication network.

5. The apparatus of claim 1, wherein the printer driver is in a computing device and wherein the language monitor is configured to trigger the one or more processors to acquire the print job related application from a memory of the computing device.

6. The apparatus of claim 1, wherein the print job related application is configured to add a print job to the printer print stream.

7. The apparatus of claim 1, wherein the print job related application is configured to append a print job to a previous print job received from the one or more processors.

8. The apparatus of claim 1, wherein the print job comprises a coupon print job.

9. The apparatus of claim 8, wherein the one or more processors are configured to count and store a number of coupon print jobs added over time to a printer print stream.

10. The apparatus of claim 9, wherein the one or more processors are configured to make available a print job for printing a redeemable reward based upon the number of coupon print jobs added to the print stream.

11. The apparatus of claim 1 further comprising a print device in communication with the one or more processors.

12. The apparatus of claim 1, wherein the print job related application is configured to trigger the one or more processors to add the print job to the printer print stream based upon a status of a previous print job received by the language monitor.

13. The apparatus of claim 1, wherein the print job related application is configured to trigger the one or more processors to add the print job to the printer print stream in response to a previously received print job being completely spooled.

14. The apparatus of claim 1, wherein the language monitor is configured to search one or more memories for the print job related applications.

15. A method comprising:
receiving, with a language monitor of a print driver on a computing device, print jobs from one or more processors;
identifying, with a language monitor of a print driver, a print job related application external to the print driver; and
directing, with a language monitor of a print driver, the one or more processors to launch the print job related application.

16. The method of claim 15 comprising:
installing the print driver;
installing the print job related application, wherein the print job related application did not exist when the print driver was installed.

17. The method of claim 17 comprising searching, with the language monitor, for print job related applications in one or more memories that have been added to the one or more memories since a previous search by the language monitor of the one or more memories.

18. The method of claim 15 comprising presenting a selectable user interface on a display screen and launching the print job related application in response to the user interface being selected by a person.

19. The method of claim 15 wherein the print job related application adds a coupon print job for a consumable based at least partially on a level of the consumable remaining in a printer.

20. A method for comprising:
receiving, with a language monitor of a print driver on a computing device, a print job from one or more processors;
adding the print job to a print stream to a printer;
triggering, with the language monitor, the one or more processors to add a print job to the print stream.
